(19) United States
(12) Patent Application Publication
(10) Pub. No.: US 2018/0142557 A1
(43) Pub. Date: May 24, 2018

(54) TURBOCHARGER IMPELLER BLADE STIFFENERS AND MANUFACTURING METHOD

(71) Applicant: BorgWarner Inc., Auburn Hills, MI (US)

(72) Inventor: Lakshmi Srikar Yellapragada, Fletcher, NC (US)

(21) Appl. No.: 15/356,577

(22) Filed: Nov. 19, 2016

(51) Int. Cl. F01D 5/04

(52) U.S. Cl. CPC F01D 5/048; F05D 2230/30; F05D 2220/40

(57) ABSTRACT

A turbocharger turbine wheel member with stiffener members thereon, together with a method of manufacture therefor are disclosed. The stiffener members are molded integrally on the turbine wheel blade members. The stiffener members, as well as the manufacturing method can be utilized also for turbocharger compressor wheel members.

### TECHNICAL FIELD

The present invention relates to turbochargers, and more particularly to improved turbine and compressor wheels for turbochargers, and methods of manufacture thereof.

### BACKGROUND OF THE INVENTION

Turbochargers are in wide use today in automobiles and other vehicles to provide increased power and response for the vehicle engines. The turbochargers include a turbine wheel, a compressor wheel and a shaft member connecting together the two wheel members. The wheels are also called “impellers”. Exhaust gas from the engine is recirculated into the turbochargers to boost the pressure in the engine and improve performance. The compressor forces more air, and proportionally more fuel, into the combustion chamber than atmospheric pressure alone.

Turbochargers are commonly used on trucks, cars, trains, aircraft and construction equipment engines. They are used most often with Otto cycle and Diesel cycle internal combustion engines.

The turbine and compressor wheels (impellers) rotate at very high speeds, typically over 100,000 rpm and as high as 200,000 rpm in some turbochargers. The size and shape of the wheels can dictate performance characteristics of the turbocharger. The wheels dictate the amount of air or exhaust that can flow through the system, and the relative efficiency at which they operate. The wheels have a number of blades which can vary in size, shape and curvature, as well as in number.

The blades on the wheels or impellers are typically designed to optimize frequency, dynamic stress and the desired flow at the peak efficiency point. The processes by which the wheels are manufactured are also designed in attempts to optimize these characteristics. Common manufacturing processes include casting, such as use of wax-pattern tools (also known as “molds”). Other manufacturing processes for turbine and compressor wheels include machining and milling from a forged product.

Manufactured wheels/impellers are tested to determine whether they meet desired operational characteristics or specifications before they are approved for use. Often, the manufactured blades of the wheels need to be clipped or otherwise altered in order to meet the desired blade frequency. These alterations can negatively affect other characteristics, such as peak thermodynamic stage frequency.

It is an object of the present invention to provide improved turbine and compressor wheels for use in turbochargers. It is another object to provide an improved method for manufacturing such wheels which can provide wheels with improved operating characteristics.

### SUMMARY OF THE INVENTION

The present invention provides improved turbine and compressor wheels, particularly for turbochargers, as well as improved methods of manufacture of such wheels.

The wheels are manufactured with stiffener members which are integrally formed on the blades. The blades are cast, such as with a lost-wax process, with the stiffeners on them. The size, shape, and location of the stiffeners on the blades are determined to increase the blade frequency. The stiffeners are oriented to have minimum impact on the efficiency of the blades and provide less dynamic stress. Preferably, the stiffeners are normal to nodal lines. Also, the stiffeners can be aligned along the direction of the flow of exhaust gas over the blades, and pass through the peak dynamic stress locations of the blades. The sizes, shapes, locations and orientations of the stiffeners can be optimized using quality wax patterns and casting wax tools.

Although the present invention is preferably designed to improve the characteristics of turbine wheels (impellers) for turbochargers, the designs and manufacturing methods can be used equally relative to compressor wheels (impellers) to similarly improve their characteristics and operation.

Other features, benefits and advantages of the present invention will become apparent from the following detailed description of the invention when considered with the accompanying drawings and appended claims.

### BRIEF DESCRIPTION OF THE DRAWINGS

FIG. 1 is a schematic representative of a turbocharger;

FIG. 2 is a perspective view of a turbocharger turbine wheel utilizing the present invention;

FIG. 3 is a side view of a turbine wheel;

FIG. 4 is an axial view of a turbine wheel illustrating use of the present invention;

FIG. 5 is another axial view of a turbine wheel illustrating use of the present invention; and

FIG. 6 is a perspective view of a compressor wheel utilizing the present invention.

FIG. 7 depicts another embodiment of the invention.

### DETAILED DESCRIPTION OF PRESENTLY PREFERRED EMBODIMENTS

The present invention can be utilized for improving the manufacture and operation of turbine wheels and compressor wheels. The “wheels” are also known as “impellers.” The present invention will be described herein primarily with respect to turbine wheels for turbochargers, but the invention can be equally used with respects to compressor wheels for turbochargers. It is also to be noted that the present invention could be utilized for turbine and compressor wheels used in applications other than turbochargers, and thus the invention is not to be limited for use only with respect to turbochargers.

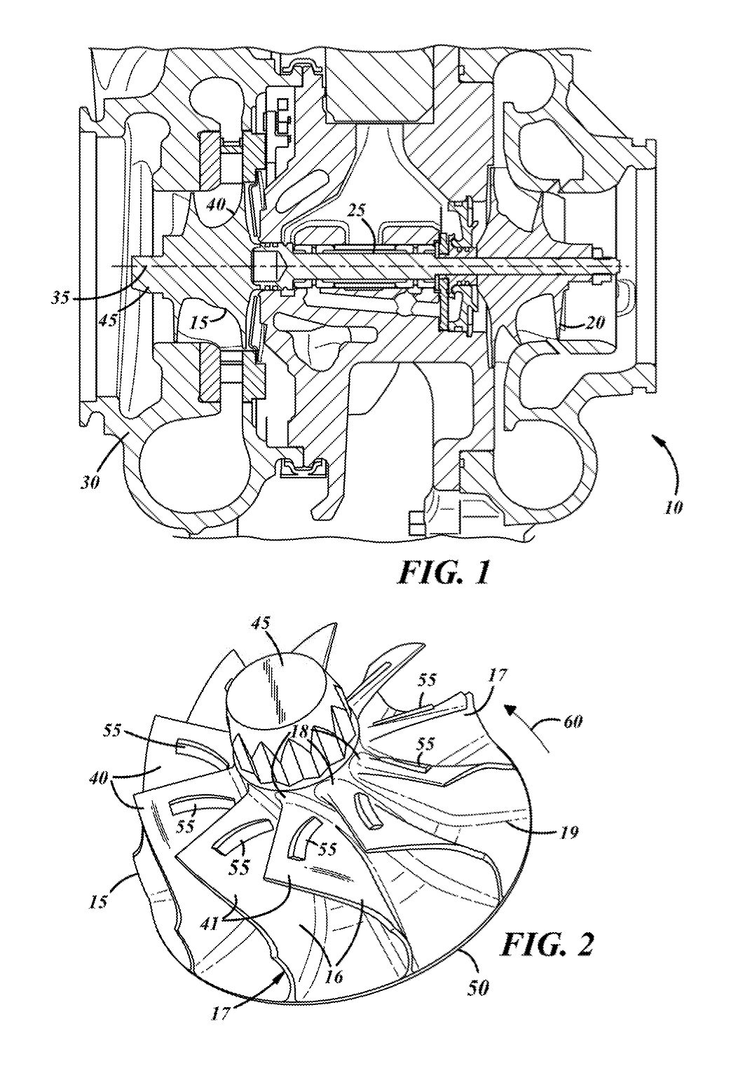

A representative turbocharger 10 is depicted in FIG. 1. The turbocharger includes a turbine wheel member 15, a compressor wheel member 20, and a shaft member 25 which connects the turbine wheel and the compressor wheel. The turbine wheel, compressor wheel and shaft are positioned in a turbocharger housing 30 and rotate around a longitudinal axis 35.

As known with turbochargers, the exhaust gas flow rotates the turbine wheel which in turn rotates the shaft member and compressor wheel at the same speed. The compressor wheel then supplies pressurized inlet gas flow to the engine to boost engine performance.

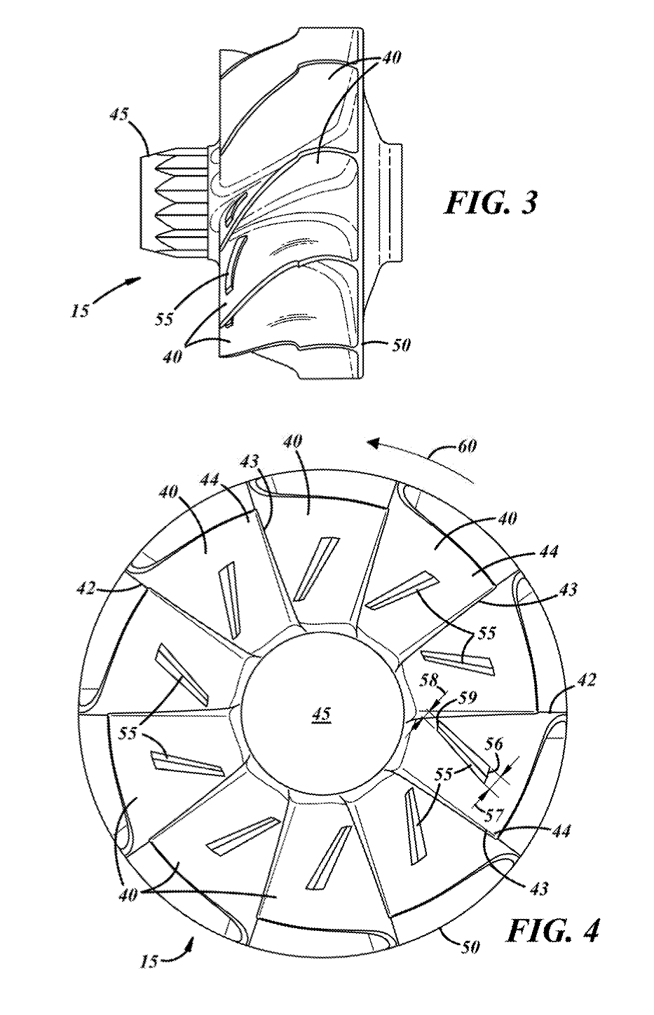

FIG. 2 is a perspective view of the turbine wheel member 15 and FIG. 3 is a side view of the turbine wheel member. The turbine wheel member 15 has a plurality of blade members 40 which are attached to a hub member 45. The size, shape and number of blade members depend on the characteristics, use and operation of the turbine and turbocharger. Typically, there are from 8-12 blades in a turbine member utilized in a turbocharger.

The blade members have a convex curved outer surface 16 (often called the “suction side” of the blades or turbine) on their axial oriented surfaces and a concave inner surface 17 (often called the “pressure side” of the blades or turbine) on the opposite surfaces. The terms “axial” and “radial” are relative to the longitudinal axis 35 of the turbine and compressor members. The blade members 40 are attached to the hub member at their radially inward edges 18 and positioned on a disk member 50 on their radially extending edges 19.

As shown in FIGS. 2, 4, and 5, stiffener members 55 are positioned on each of the blade members 40. The stiffener members can have any desired size and shape that provides the benefits and advantages of the invention, particularly to increase the frequency of the blades. Preferably, the stiffener members 55 are oriented longitudinally (radially) on the axial outer surfaces 41 of the turbine blades 55, as shown. The location and positions of the stiffeners on that surface are determined where they have minimum impact on the efficiency of the blades, as well as provide less dynamic stress.

The stiffener members 55 can be aligned along the desired direction of flow of the exhaust gas over the blades, and pass through the peak dynamic stress locations of the blades. The stiffeners preferably are aligned normal to the nodal lines as discussed later. The direction of rotation of the turbine wheel 15 is shown by arrows 60 in FIGS. 2, 4 and 5. The blades 40 have leading edges 42, trailing edges 43, and radially outer corners 44 which can be sharp (as shown) or rounded as desired. The longitudinal orientations of the stiffener members 55 are preferably slanted toward the corners 44. In addition, the stiffener members 55 are preferably located closer to the trailing edges 43 than the leading edges 42 on the blade members.

The stiffener members also can have the shapes shown in FIG. 4 in which the radially outer ends 56 of the stiffeners have a circumferential width 57 which is greater than the circumferential width 58 at the opposite ends 59. This shape is not critical, however, and other sizes and shapes of the stiffener members can be utilized. Often, the shape of the stiffener members is dependent on the method by which the casting tools are opened once the wheel member is cast and finished.

One of the purposes of the stiffener member is to improve the characteristics of the turbine wheels for turbochargers and prevent reduction of the efficiency of the wheels by post manufacture alteration of the blades, such as by clipping, in order to alter the frequency of the blades and the overall frequency of the turbine wheel and turbocharger. For this purpose, the stiffener members 55 are integrally molded on the turbine wheel blades when the turbine wheels are manufactured. Thus, when the turbine wheels are made, the stiffener members are formed integrally as part of the blade members. The as-cast blade stiffener design and the location of the stiffeners on the axially outer sides of the impeller blades increase the blade frequency. As indicated above, the stiffener members 55 are located and oriented to have a minimal impact on the blade and turbine wheel efficiency and to lower the dynamic stress.

The preferred method for manufacture of the turbine wheel with the integral stiffener members is to use an investment casting process, such as a lost wax process. With this method, the stiffener members are designed and added to the wax tool (mold). Persons of skill in the art would also know that it is possible to use other casting and manufacturing methods to provide turbine wheels with integrally formed stiffener members.

With the invention, expensive and time-consuming operations, such as clipping, used to alter the frequency of the turbine blades and turbine wheel are avoided. The clipping process is used to grind away portions of the blade members, such as on the trailing edges 43, to alter the frequency of the turbine member. The stiffener members improve the blade frequency. With the invention, it is not necessary to machine the blade members or turbine wheels after they are molded for frequency reasons.

Preferably the stiffener members 55 have a constant thickness along their lengths on the blade, with the thickness being measured as the height from the blade surface 41. It is also possible for the stiffener members to increase in thickness adjacent the outer edges of the blades. The upper/outer surfaces of the stiffeners are also preferably flat. The edges of the stiffener members are also preferably rounded and, as mentioned above, preferably increase in width in a circumferential direction from the hub to the outer edges of the blades.

As shown particularly in FIG. 5, the stiffener members 55 are preferably oriented substantially perpendicular to the nodal lines 70 on the blade members. FIG. 5 depicts the deformation of the tip edges 43 of the blade members 40 in use. The nodal lines 70 depict the increasing deformation of the blade members with the most deformation at the tip corners 44. The areas of the blade members adjacent the tip edges become increasingly more deformed the closer to the outer edges.

It is also possible to provide two or more stiffener members on each blade member. This is shown in FIG. 7. Here two stiffener members 90 and 92 are provided on the blades 94 of a wheel (impeller) member 96. If two stiffeners are utilized, one can be positioned adjacent the leading edge of the wheel and the other stiffeners can be positioned adjacent the trailing edge.

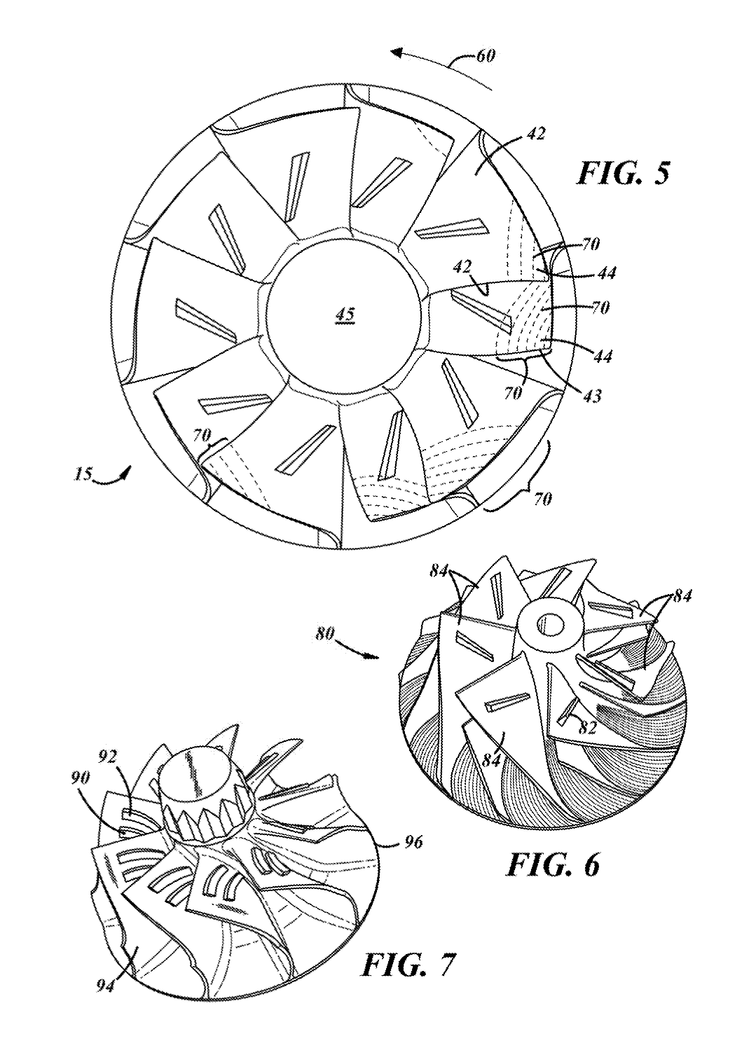

As indicated above, the present invention has similar use and benefits for compressor wheels. FIG. 6 depicts a compressor wheel 80 with stiffener members 82 positioned on the blade members 84. The size, shape, orientation and location of the stiffener members 82 on the compressor wheel blades can be the same as these described above with respect to turbine wheels.

For turbine wheel members with lower blade modes, the stiffener members are preferably positioned closer to the trailing edge of the blades. For higher blade modes, the stiffeners are preferably positioned closer to the leading edges of the blades. For compressor wheel members, the positioning of the stiffener members are the opposite of the positioning on turbine wheel members. Thus, for compressor wheel members with lower blade modes, the stiffener members are positioned closer to the leading edges of the blades. For compressor wheel members with higher blade modes, the stiffener members are preferably positioned closer to the trailing edges.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A turbocharger turbine wheel member comprising a hub member and a plurality of blade members, each of the blade members having a first axial oriented surface relative to the longitudinal axis, and a plurality of stiffener members, at least one of said stiffener members being located on each of said axial oriented surfaces.

2. The turbocharger turbine wheel member as described in claim 1 wherein said blade members each have a radially outward edge and wherein said stiffener members are oriented in a direction toward said radially outward edge.

3. The turbocharger turbine wheel member as described in claim 2 wherein said stiffener members are positioned substantially perpendicular to nodal lines adjacent said radially outward edge.

4. The turbocharger turbine wheel member as described in claim 1 wherein said stiffener members are cast integrally on said blade members.

5. The turbocharger turbine wheel member as described in claim 1 wherein at least two of said stiffener members are located on each of said blade members.

6. A method of manufacturing a turbine wheel member, said turbine wheel member having a plurality of blade members and stiffener members located on each of said blade members, said method comprising the steps of:
producing a mold with a cavity in the form of said turbine wheel member with stiffener members on each of said blade members;
molding said turbine wheel member in said mold;
wherein said turbine wheel member is formed with at least one stiffener member integrally molded and formed thereon.

7. The method of manufacturing a turbine member as described in claim 6, wherein said blade members each have a radially outward edge and wherein said stiffener members are oriented in a direction toward said radially outward edge.

8. The method of manufacturing a turbine member as described in claim 7, wherein said stiffener members are positioned substantially perpendicular to nodal lines adjacent said radially outward edge.

9. The method of manufacturing a turbine member as described in claim 6 wherein at least two stiffener members are formed and integrally molded on each of said blade members.

10. The method of manufacturing a turbine member as described in claim 6 wherein said molding is an investment casting process.

11. An impeller member comprising a hub member and a plurality of blade members, each of the blade members having a first axial oriented surface relative to the longitudinal axis, and a plurality of stiffener members, at least one of said stiffener members being located on each of said axial oriented surfaces.

12. The impeller member as described in claim 11 wherein said blade members each have a radially outward edge and wherein said stiffener members are oriented in a direction toward said radially outward edge.

13. The impeller member as described in claim 12 wherein said stiffener members are positioned substantially perpendicular to nodal lines adjacent said radially outward edge.

14. The impeller member as described in claim 11 wherein said stiffener members are cast integrally on said blade members.

15. The impeller member as described in claim 11 wherein at least two of said stiffener members are located on each of said blade members.

16. A method of manufacturing an impeller member, said impeller member having a plurality of blade members and stiffener members located on each of said blade members, said method comprising the steps of:
producing a mold with a cavity in the form of said impeller member with stiffener members on each of said blade members;
molding said impeller member in said mold;
wherein said impeller wheel member is formed with at least one stiffener member integrally molded and formed thereon.

17. The method of manufacturing an impeller member as described in claim 16 wherein said blade members each have a radially outward edge and wherein said stiffener members are oriented in a direction toward said radially outward edge.

18. The method of manufacturing an impeller member as described in claim 17 wherein said stiffener members are positioned substantially perpendicular to nodal lines adjacent said radially outward edge.

19. The method of manufacturing an impeller member as described in claim 16 wherein at least two stiffener members are formed and integrally molded on each of said blade members.

20. The method of manufacturing an impeller member as described in claim 16 wherein said molding is an investment casting process.
